(19) United States
(12) Patent Application Publication
(10) Pub. No.: US 2025/0238929 A1
(43) Pub. Date: Jul. 24, 2025

(54) METHOD AND SYSTEM FOR IMAGE PROCESSING USING SEGMENTATION

(71) Applicant: HERE Global B.V., Eindhoven (NL)

(72) Inventors: Dev SAVLA, Mumbai (IN); Senjuti SEN, West Bengal (IN); Karan SAHU, Wardha (IN); Deekshant SAXENA, Navi Mumbai (IN)

(21) Appl. No.: 18/986,279

(22) Filed: Dec. 18, 2024

Related U.S. Application Data
(60) Provisional application No. 63/614,108, filed on Dec. 22, 2023.

(51) Int. Cl. G06T 7/10

(52) U.S. Cl. CPC G06T 7/10; G06T 2207/20221

(57) ABSTRACT

The disclosure provides a method, a system, and a computer program product for image processing using segmentation. The system is configured to, for example, obtain image data associated with one or more sensors associated with a user device. Further the system is configured to determine count data associated with one or more cores of a processor of the user device. The image data is segmented into one or more segments based on the count data. Each of the one or more segments of the image data are processed with a corresponding core of the one or more cores of the processor of the user device. Each of the processed one or more segments of the image data are then combined to form combined processed image data.

### RELATED APPLICATION

This application claims priority to U.S. Provisional Patent Application No. 63,614,108, titled “Method and System for Image Processing Using Segmentation,” filed on Dec. 22, 2023, the contents of which are hereby incorporated by reference in its entirety.

### TECHNICAL FIELD

The present disclosure generally relates to image processing and more particularly relates to image processing using segmentation.

### BACKGROUND

Image processing, a fundamental domain in computer vision involves the manipulation and analysis of visual data to extract meaningful information. It plays a vital role in various applications, from enhancing image quality to enabling complex computer vision tasks like object detection and object recognition.

Multi-threading is a parallel computing technique where multiple threads run concurrently within a program. In context of image-processing, multi-threading becomes crucial for efficient utilization of computer resources. By dividing the image-related tasks into parallel threads, it enables simultaneous processing of distinct parts of an image enhancing the speed and performance of image analysis process.

Currently, to speed up the image processing process, Compute Unified Device Architecture (CUDA) based Graphics Processing Unit (GPU) are used instead of CPU, which involve additional cost of GPU. In common, to process the image on CPU, which involves underutilization of CPU resources in a multi-core system. Sometimes, images are downscaled for speeding up their processing, but downscaling the image and then processing is also inefficient, as it impacts the accuracy of image processing task to a great extent.

Based on the foregoing discussion, there exists a need for an efficient system and method that overcomes the above stated disadvantages.

### BRIEF SUMMARY

The present disclosure provides methods and systems that enable faster and more efficient image processing, by leveraging multi-threaded CPU architectures. Some embodiments provide deep learning based image processing which leverages multi-threading architecture to efficient utilize entire CPU power, providing for faster and efficient image processing. The multi-threading architecture may utilize a master thread that may divide the image processing among the available CPU resources. The multi-threaded architecture may use parallelized approach for image processing and may segment image data for processing by available cores of the CPU for faster and efficient image processing. The disclosure further discloses functionality of combining the processed image data from each of the available core of the CPU and collating the processed image data for further usage and analysis applications.

Example embodiments of the present disclosure provide a method, a system, and a computer program product for image processing, which may be further used for inference engine optimization.

In one aspect, a method for image processing using segmentation is provided. The method may comprise obtaining image data associated with one or more sensors associated with a user device. The method may further comprise determining count data associated with one or more cores of a processor of the user device. Further, the method may comprise segmenting the image data into one or more segments based on the count data. The method may further comprise processing each of the one or more segments of the image data with a corresponding core of the one or more cores of the processor of the user device. Further, the method may comprise combining each of the processed one or more segments of the image data to form combined processed image data.

In additional method embodiments, each of the one or more segments of the image data may be associated with a segment identifier, and each of the one or more cores of the processor of the user device may be associated with a core identifier.

In additional method embodiments, the method may further comprise combining each of the processed one or more segments of the image data based on the segment identifier and the core identifier.

In additional method embodiments, the method may further comprise segmenting each of the one or more segments of the image data into one or more sub-segments based on the corresponding core. Further, the method may comprise processing each of the one or more sub-segments of a segment of the one or more segments with a corresponding sub-core of the corresponding core of the one or more cores of the processor of user device.

In additional method embodiments, the method may further comprise segmenting, using a master process, the image data into the one or more segments. Further, the method may comprise allocating, using the master process, each of the one or more segments to the corresponding core of the one or more cores of the processor of the user device.

In additional method embodiments, the method may further comprise generating a navigation instruction based on the combined processed image.

In additional method embodiments, the method may further comprise storing the combined processed image in a map database.

In additional method embodiments, the processing of each of the one or more segments of the image data with a corresponding core of the one or more cores may be performed in parallel.

In additional method embodiments, the count data may be indicative of a number of available cores of the processor of the user device, for processing the image data.

In another aspect, a system for image processing using segmentation is disclosed. The system may comprise a memory configured to store computer-executable instructions, and at least one processor configured to execute the computer-executable instructions to obtain image data associated with one or more sensors associated with a user device. The at least one processor may be further configured to determine count data associated with one or more cores of a processor of the user device. The at least one processor may be further configured to segment the image data into one or more segments based on the count data. Further, the at least one processor may be configured to process each of the one or more segments of the image data with a corresponding core of the one or more cores of the processor of the user device. The at least one processor may be further configured to combine each of the processed one or more segments of the image data to form combined processed image data.

In additional system embodiments, each of the one or more segments of the image data may be associated with a segment identifier, and each of the one or more cores of the processor of the user device may be associated with a core identifier.

In additional system embodiments, the at least one processor may be further configured to combine each of the processed one or more segments of the image data based on the segment identifier and the core identifier.

In additional system embodiments, the at least one processor may be further configured to segment each of the one or more segments of the image data into one or more sub-segments based on the corresponding core. The at least one processor may be further configured to process each of the one or more sub-segments of a segment of the one or more segments with a corresponding sub-core of the corresponding core of the one or more cores of the processor of user device.

In additional system embodiments, the at least one processor may be further configured to segment, using a master process, the image data into the one or more segments. Further, the at least one processor may be configured to allocate, using the master process, each of the one or more segments to the corresponding core of the one or more cores of the processor of the user device.

In additional system embodiments, the at least one processor may be further configured to generate a navigation instruction based on the combined processed image.

In additional system embodiments, the at least one processor is further configured to store the combined processed image in a map database.

In additional system embodiments, the processing of each of the one or more segments of the image data with a corresponding core of the one or more cores may be performed in parallel.

In additional system embodiments, the count data may be indicative of a number of available cores of the processor of the user device, for processing the image data.

In yet another aspect, a computer program product comprising a non-transitory computer readable medium having stored thereon computer executable instructions which when executed by at least one processor, cause the processor to carry out operations for image processing using segmentation. The operations may comprise obtaining image data associated with one or more sensors associated with a user device. The operations may further comprise determining count data associated with one or more cores of a processor of the user device. Further, the operations may comprise segmenting the image data into one or more segments based on the count data. The operations may further comprise processing each of the one or more segments of the image data with a corresponding core of the one or more cores of the processor of the user device. Further, the operations may comprise combining each of the processed one or more segments of the image data to form combined processed image data.

In additional computer program product embodiments, the operations may further comprise segmenting each of the one or more segments of the image data into one or more sub-segments based on the corresponding core. The operations may further include processing each of the one or more sub-segments of a segment of the one or more segments with a corresponding sub-core of the corresponding core of the one or more cores of the processor of user device. The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a schematic diagram of a network environment of a system for processing an image, in accordance with an example embodiment;

FIG. 2A illustrates a block diagram of the system of FIG. 1, in accordance with an example embodiment;

FIG. 2B illustrates an exemplar map database record storing data, in accordance with one or more example embodiments;

FIG. 2C illustrates another exemplar map database record storing data, in accordance with one or more example embodiments;

FIG. 2D illustrates another exemplar map database storing data, in accordance with one or more example embodiments;

FIG. 3 illustrates a block diagram of a method for image processing using segmentation, in accordance with one or more example embodiments;

FIG. 4 illustrates a block diagram of an image data segmentation pipeline for image processing, in accordance with one or more example embodiments;

FIG. 5 illustrates a block diagram of another image data segmentation pipeline for image processing, in accordance with one or more example embodiments;

FIG. 6 illustrates a flow chart of a method for image processing, in accordance with one or more example embodiments; and

FIG. 7 illustrates a flow chart of another method for image processing, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Image processing is a wide application field which may be used in a variety of technical services and products. Some of these services and products include such as mapping and navigation, image classification, medical procedures, surveillance services, and the like. With increasing usage of machine learning in all technical aspects in present times, image processing applications are also increasingly being used in conjunction with machine learning and deep learning applications. One of these applications is inference engine optimization, which involves improving the efficiency and performance of an inference process within a machine learning or artificial intelligence (AI) system. The inference engine is the component responsible for applying a trained model to new data to make predictions or decisions.

Currently to speed-up the inference in the inference engine, CUDA based GPU are used instead of CPU which involve additional cost of GPU. In common, to process the image on CPU only single thread is utilized which leads to longer prediction time. Single threaded processing on CPU involves underutilization of CPU resources on multi-core system.

Accordingly, various embodiments provide methods and systems to efficiently utilize CPU resources for tasks related image processing, which may further be associated with variety of applications such as object classification and detection, video processing, General Adversarial Network (GAN), and the like. Some embodiments provide systems and method for performing inference optimization using images processed through a multi-threaded CPU architecture that efficiently utilizes multiple cores of a processor, such as the CPU, to provide faster and accurate inference optimization. Further, using the existing CPU, and not requiring additional GPU or other hardware for image processing disclosed in the various embodiments herein makes the image processing task cheaper than other systems requiring additional resources like the GPU.

Accordingly, some embodiments provide a multi-threading processor architecture involving a master thread for dividing a task among available processor or CPU resources, and an output combiner for collating outputs of different resources. In some embodiments, the resources and different available cores of the processor, and the task is image processing for an input image. The input image is segmented in different segments, and each segment is processed by a different core of the processor. After processing, the different processed segments are combined and the combined image is used for further processing. The various embodiments thus provide faster data processing and considerably lower down the cost of the entire system.

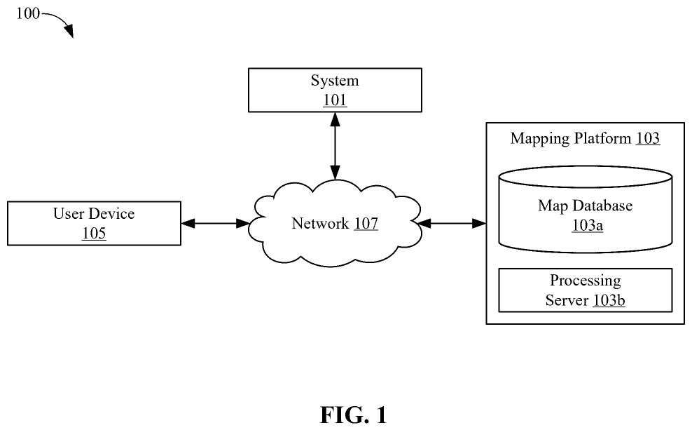

FIG. 1 illustrates a schematic diagram of a network environment 100 of a system 101 for image processing using multi-threading architecture, in accordance with an example embodiment. The system 101 may be communicatively coupled to a mapping platform 103, and a user device 105 via a network 107. The components described in the network environment 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud based application, a remote server based service, a remote server based application, a virtual computing system, a remote server platform or a cloud based platform. As such, the system 101 may be configured to operate outside the user device 105.

In operation, the system 101 may be configured to obtain image data from one or more sensors. The one or more sensors may be associated with the user device 105. In an embodiment, the one or more sensors may be but not limited to, camera sensors, radar sensors, LIDAR sensors and the like. The image data may include images obtained from different sources, such as frames of a video collected from different video sources such as a CCTV camera, images obtained from drive files, images obtained from drone files, satellite imagery, and the like. In an embodiment, the image data may be images or frames from a video streams that may be captured by the camera sensors. For example, the image may be of a road scenario like but not limited to images of road, images of other vehicles, the images of pedestrians, buildings, POIs, lane markings, terrain features.

Further, the system 101 may be configured to determine count data associated with one or more cores of the processor of the user device 105. In an embodiment, the count data may be the number of cores present in the processor of the user device 105. For example, the processor being a quad core processor, the count data determined by the system 101 may be four. The count data is used to segment the image data into one or more segments, such that the number of segments is equivalent to the number of cores of the processor of the user device. Thus, for the quad core example described above, the image data for an input image is segmented into four segments. The image data comprises image related parameters such as pixel values, intensity values, spatial coordinated associated with different pixels in the image and the like. Segmenting the image into different segments indicated by the count data includes dividing the image into distinct regions.

Further, the system 101 may be configured to process each of the one or more segments of the image data with a corresponding core of the one or more cores of the processor of the user device 105. Each segment of the image data may be associated with a segment identifier (also referred to hereinafter as segment-ID) and each core of the processor of the user device 105 may be associated with a core identifier (also referred to hereinafter as core-ID). In an embodiment, each of the one or more segment of the image data may be associated with a unique segment-ID. Further, each of the one or more cores of the processor associated with the user device 105 is associated with a unique core-ID. The segment-ID and the core-ID provide indicators for identifying which segment of the image data should be processed by which core of the processor of the user device 105. For example, while processing the four segments of the image data, the segment of the image data with a segment-ID: 1 may be processed in the core of the processor associated with the user device 105 with core-ID: 1, the segment of the image data with a segment-ID: 2 may be processed in the core of the processor associated with the user device 105 with core-ID: 2, and the like.

Further, the system 101 is configured to combine each of the processed one or more segments of the image data to form a combined processed image data. The combined processed image may then be used for further analysis, storage or applications.

In one embodiment, the combined processed image is stored in a map database 103a of the mapping platform 103. The mapping platform 103 may use the combined processed image, either in real-time or by accessing stored image from the map database 103a for navigation and mapping related operations, such as generating navigation instructions, providing a map display, generating an optimized route for travel between a source location and a destination location, asset mapping and tracking, drone navigation and delivery operation, and the like.

In an embodiment, the system 101 may transmit the combined processed image to the mapping platform 103 via the network 107. To that end, the system 101 may be communicatively coupled to the user device 105 and the mapping platform 103 via the network 107.

The mapping platform 103 may comprise the map database 103a for storing map data and a processing server 103b. The map database 103a may store node data, road segment data, link data, point of interest (POI) data, link identification information, heading value records, data about various geographic zones, regions, pedestrian data for different regions, heat maps or the like. Also, the map database 103a further includes speed limit data of different lanes, cartographic data, routing data, and/or maneuvering data. Additionally, the map database 103a may be updated dynamically to cumulate real time traffic data. The real time traffic data may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In an embodiment, the map database 103a may store data of different zones in a region. In one embodiment, the map database 103a may further store historical traffic data that includes travel times, average speeds and probe counts on each road or area at any given time of the day and any day of the year. In an embodiment, the map database 103a may store the probe data over a period of time for a vehicle to be at a link or road at a specific time. The probe data may be collected by one or more devices in the vehicle such as one or more sensors or image capturing devices or mobile devices. In an embodiment, the probe data may also be captured from connected-car sensors, smartphones, personal navigation devices, fixed road sensors, smart-enabled commercial vehicles, and expert monitors observing accidents and construction. In an embodiment, the map data in the map database 103a may be in the form of map tiles. Each map tile may denote a map tile area comprising plurality of road segments or links in it. According to some example embodiments, the road segment data records may be links or segments representing roads, streets, or paths, as may be used in calculating a route or recorded route information for determination of one or more personalized routes. The node data may be ending points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link and nodes can be associated with attributes, such as geographic coordinates, street names, address ranges, speed limits, turn restrictions at intersections, and other navigation related attributes. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

As mentioned above, the map database 103a may be a master geographic database, but in alternate embodiments, the map database 103a may be embodied as a client-side map database and may represent a compiled navigation database that may be used in or with end user equipment such as the user device 105 to provide navigation and/or map-related functions. For example, the map database 103a may be used with the user device 105 to provide an end user with navigation features. In such a case, the map database 103a may be downloaded or stored locally (cached) on the user device 105.

The processing server 103b may comprise processing means, and communication means. For example, the processing means may comprise one or more processors configured to process requests received from the user device 105. The processing means may fetch map data from the map database 103a and transmit the same to the user device. In one or more example embodiments, the mapping platform 103 may periodically communicate with the user device 105 via the processing server 103b to update a local cache of the map data stored on the user device 105. Accordingly, in some example embodiments, the map data may also be stored on the user device 105 and may be updated based on periodic communication with the mapping platform 103.

In some example embodiments, the user device 105 may be any user accessible device such as a mobile phone, a smartphone, a portable computer, and the like, as a part of another portable/mobile object such as a vehicle. The user device 105 may comprise a processor, a memory, and a communication interface. The processor, the memory and the communication interface may be communicatively coupled to each other. In some example embodiments, the user device 105 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user device 105 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user device 105. Additional, different, or fewer components may be provided. In one embodiment, the user device 105 may be directly coupled to the system 101 via the network 107. For example, the user device 105 may be a dedicated vehicle (or a part thereof) for gathering data for development of the map data in the database 103a. In some example embodiments, the user device 105 may serve the dual purpose of a data gatherer and a beneficiary device. The user device 105 may be configured to capture sensor data associated with a road which the user device 105 may be traversing. The sensor data may for example be image data of road objects, road signs, or the surroundings. The sensor data may refer to sensor data collected from a sensor unit in the user device 105. In accordance with an embodiment, the sensor data may refer to the data captured by the vehicle using sensors. The user device 105 may be communicatively coupled to the system 101, the mapping platform 103 over the network 107.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example embodiment, the system may be integrated in the user device 105. In an example, the mapping platform 103 may be integrated into a single platform to provide a suite of mapping and navigation related applications for OEM devices, such as the user devices and the system 101. The system 101 may be configured to communicate with the mapping platform 103 over the network 107.

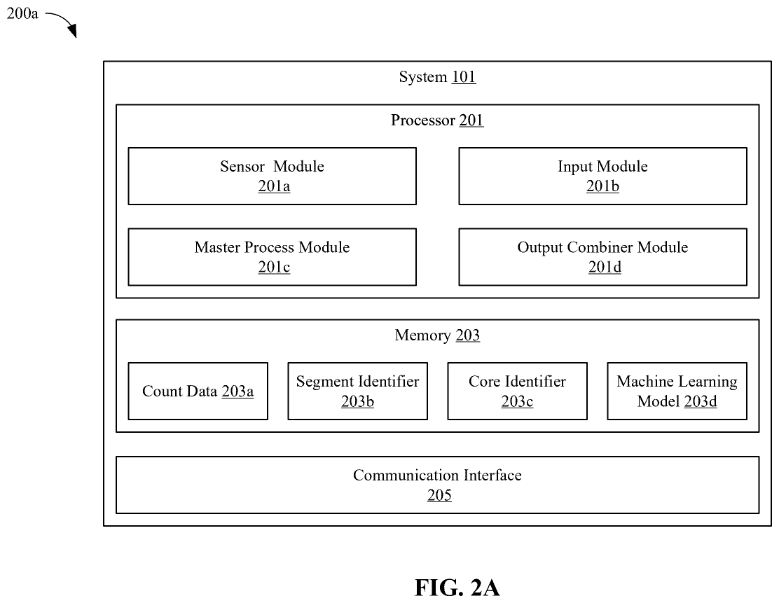

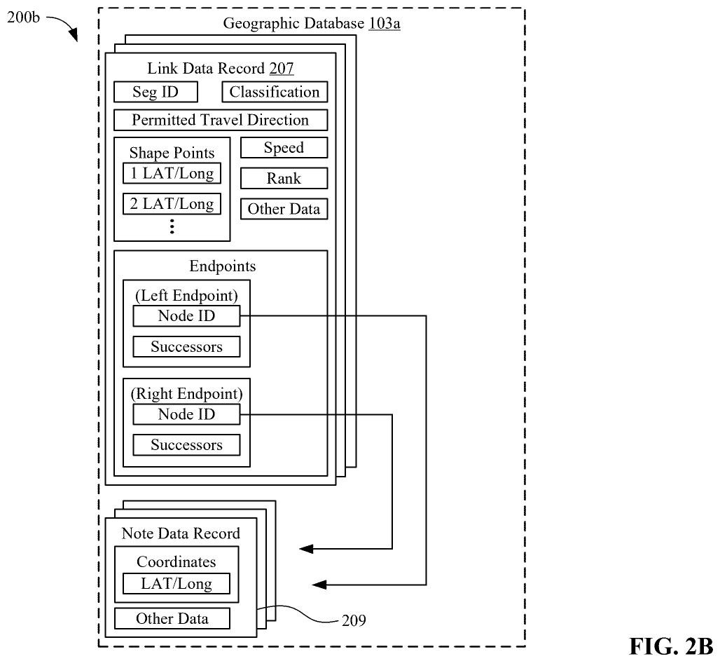

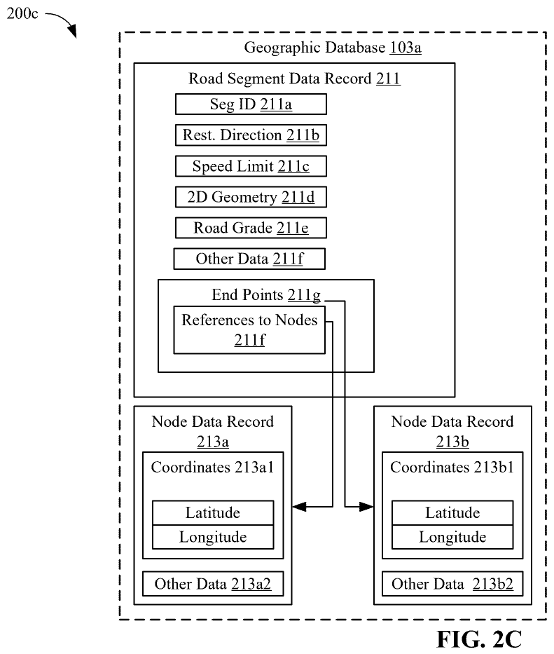

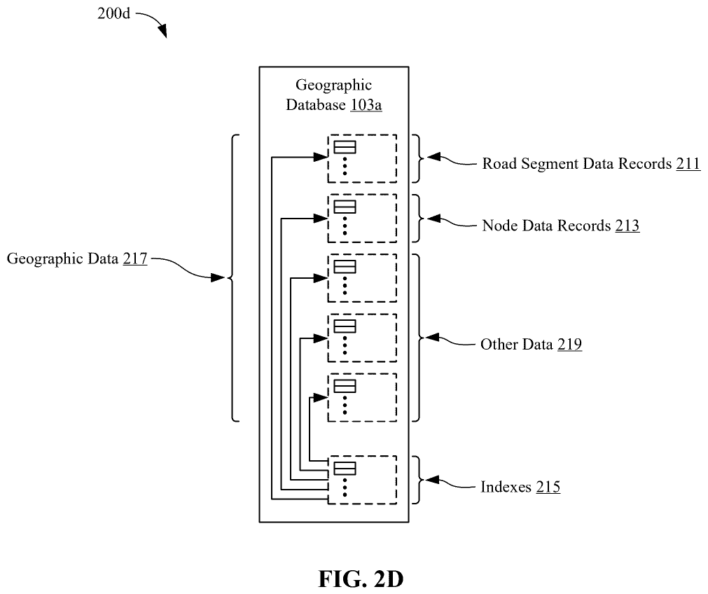

FIG. 2A illustrates a block diagram 200a of the system 101 for image processing, in accordance with an example embodiment. The system 101 may include at least one processor 201 (hereinafter, also referred to as “processor 201”), at least one memory 203 (hereinafter, also referred to as “memory 203”), and at least one communication interface 205 (hereinafter, also referred to as “communication interface 205”). The processor 201 may include a sensor module 201a, an input module 201b, a master process module 201c, and an output combiner module 201d. The processor 201 may retrieve computer program code instructions that may be stored in the memory 203 for execution of the computer program code instructions. The memory 203 may include count data 203a, a segment identifier 203b, a core identifier 203c. Additionally or alternatively, the memory may store a machine learning model 203d.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes and the like, big data analysis, traffic redirection, and sensor-based data collection by using the cloud-based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The sensor module 201a may be configured to receive data from one or more sensors including but not limited to acoustic sensors such as a microphone array, position sensors such as a GPS sensor, a gyroscope, a LIDAR (Light detection and tanging) sensor, a proximity sensor, motion sensors such as accelerometer, an image sensor such as a camera and the like. Different sensors equipped in a vehicle can be used for perception and localization detection which are two of the fundamental technologies in autonomous driving. A radar sensor is used to detect the object's distance, velocity, range, by sending radio waves. The LIDAR sensor is used to determine the object's distance by creating the 3D rendering images of the autonomous driving vehicle's surrounding by spinning laser emitting millions of light pulses per second to view and measure each point the laser scanned. In some embodiments, the sensor module includes processing instructions for processing data if one or more sensors for image capturing and detection. For example, the one or more sensors include a camera. The camera may be used to capture image data associated with one or more objects in an environment of the user device 105. In an embodiment, when the user device 105 is installed in a vehicle, the camera captures image data of objects in the environment of the vehicle. Such objects include, for example, road objects, other vehicles, pedestrians, buildings, POIs, lane markings, terrain features, and the like.

In an embodiment, the user device 105 may be an unmanned aerial vehicle (UAV) (equivalently referred to as a “drone”), and the one or more sensors are configured to capture image data of objects detected by the UAV during a flight.

In an embodiment, the user device 105 may be a satellite and the one or more sensors are configured to capture satellite imagery of different geographical features on the earth for different geographic regions. These different geographic features include such as streets, roads, lanes, buildings, natural physical landforms like water bodies, mountains, other landforms and the like.

In an embodiment, the image data is captured using computer vision technologies and then pre-processed using a convolutional neural network (CNN) or a deep neural network (DNN) machine learning image technologies. Additionally or alternatively, the sensor module 201a may include or be coupled with satellite system like GPS, GLONASS, BEIDOU, together with Wi-Fi, Bluetooth, and inertial sensors like gyro and accelerometer to determine a precise location for the user device 105 associated with the system 101. In some embodiments, the sensor module includes V2X sensors (4G/5G modem) that help exchange the information including real time traffic, road hazard, weather, parking between the autonomous driving vehicle and back end infrastructure.

To that end, the sensor module 201a may be configured to acquire sensor data and vehicle data from the user device 105. The sensor data may be associated with a region including a plurality of roads. The region is a bounding region and is defined by making a polygon around the region in a map display. In one embodiment, the sensor data and the vehicle data is obtained from a connected vehicle during a drive. The sensor module 201a is configured to receive dynamic data from a server based on the reception of the sensor data. Dynamic data may include weather data, traffic data, incident data, map data, hazard warning data, traffic pattern data, and the like. The sensor data indicates at least one of a driving condition of the vehicle in the region or a surrounding environmental condition of the vehicle. The sensor data may include all the sensors equipped to detect the vehicle driving conditions or its surrounding driving environments like road signs, road conditions, and the like.

The input module 201b may be configured to receive data acquired by the sensor module 201a and manage the received data for further processing by the processor 201. The data acquired by the sensor module 201a may correspond to the image data associated with one or more sensors associated with the user device 105. The input module 201b may receive the image data and feed it to the master process module 201c for further processing.

In an embodiment, the input module 201b may receive the image data that may be associated to CCTV camera feeds such as but not limited to, input from surveillance cameras, such as CCTV camera that may monitor urban areas, providing real-time footage of roads and public spaces. Further the input module 201b may receive data that may be sourced from recorded drive files, including dash-cam footage or recorded journeys, contributing valuable data for processing road-related information. The input module 201b may also receive drone captured imagery. The drone captured imagery may offer an aerial perspective of landscapes, roads and infrastructure that may provide broader context for image processing. The input module 201b may also receive predefined datasets that may be related to road scenarios.

The master process module 201c may be configured to segment the image data that may be received from the input module 201b into one or more segments based on the number of cores present in the processor of the user device 105. The processor 201 of the system 101 may further use master process module 201c to allocate each of the one or more segments of the image data to the corresponding core of one or more cores of the processor of the user device 105.

In an exemplary embodiment, the image data may be received from the input module 201b. In order to segment the image data into one or more segments, the processor 201 of the system 101 may determine the number of cores that may be present in the processor of the user device 105. Upon the determination of the number of cores that may be present in the processor of the user device 105, the processor 201 may use the master process module 201c to segment the image data based on the determined number of cores. The processor 201 of the system 101 may further use the master process module 201c to allocate each of the one or more segments of the image data to the corresponding core of one or more cores of the processor of the user device 105.

The output combiner module 201d may be configured to combine each of the processed one or more segments of the image data to form a combined processed image data.

In an exemplary embodiment, the processor 201 associated with the system 101 may include the output combiner module 201d. The output combiner module 201d may receive the processed one or more segments of the image data that may be processed in the one or more cores of the processor associated with the user device 105. The output combiner module 201d may combine the each of the processed segments of the image data and output the combined processed image data. The processor 201 associated with the system 101 may generate navigation instructions based on the combined processed image.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to conduct various functions in accordance with an example embodiment of the present invention. For example, the memory 203 may be configured to buffer input data for processing by the processor 201.

As exemplarily illustrated in FIG. 2A, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The memory 203 stores the count data 203a, the segment identifier 203b, the core identifier 203c, and the machine learning model 203d. The count data 203a stored in the memory 203 may store the number of cores present in the processor of the user device 105. The core within a processor may be an independent processing unit. Each core may be capable of executing its own set of instructions, allowing the processor of the user device 105 to handle multiple tasks simultaneously. There may be multi-core processors, for example, dual-core processors, quad-core processors, there may be multiple cores working in parallel that may significantly improve the overall performance and efficiency of the processor of the user device 105.

In an exemplary embodiment, the processor of the user device 105 being a quad-core processor, the count data 203a stored in the memory 203 may be four as there are four cores in the quad core processor. In another exemplary embodiment, the processor of the user device 105 being a dual core processor, the count data 203a stored in the memory 203 may be two as there are two cores in the dual core processor.

The segment identifier 203b stored in the memory 203 may be a numerical value or an alphanumerical value that indicates an identifier, also referred to as segment-ID given to each segment of the image data. The processor 201 associated with the system 101 may segment the image data based on the count data 203a and assign segment-ID to each segment in the segmented or partitioned image data.

In an exemplary embodiment the processor 201 associated with the system 101 may utilize the count data 203a to efficiently segment the image data using the master process module 201c. In an embodiment, the image data may be partitioned into four distinct quadrants based on the count data 203a being four. Each segment of the image data may correspond to the core within the processor of the user device 105. Each quadrant is then assigned a segment-ID. For example, a first quadrant of the image data may be associated with segment-ID 1, a second quadrant of the image data may be associated with segment-ID 2, a third quadrant of the image data may be associated with segment-ID 3 and a fourth quadrant of the image data may be associated with segment-ID 4.

The core identifier 203c stored in the memory 203 may indicate a unique core-ID that may be associated to each of the one or more cores of the processor associated with the user device 105.

In an exemplary embodiment, the processor of the user device 105 being a quad core processor, the first core of the processor of the user device 105 may be associated with the core-ID 1, the second core of the processor of the user device 105 may be associated with the core-ID 2, the third core of the processor of the user device 105 may be associated with the core-ID 3 and the fourth core of the processor of the user device 105 may be associated with the core-ID 4.

The machine learning model 203d stored in the memory may be CNN based model that may be initially trained on dataset specially for application domain such as but not limited to road scenarios. During training the machine learning model 203d may learn to recognize and interpret features within the image data, enabling it to perform tasks such as but not limited to object detection, object recognition and classification.

In an embodiment, the machine learning model 203d is optimized using a TensorRT™ engine. TensorRT™ is a high-performance deep learning inference optimizer and runtime library developed by NVIDIA™. It's designed to optimize and deploy trained neural network models for inference. TensorRT™ takes trained neural networks, optimizes them for runtime efficiency, and generates runtime engines that deliver low-latency, high-throughput inference for various applications, including image classification, object detection, natural language processing, and more.

In an embodiment, the TensorRT™ engine generates an optimized ONNX, or Open Neural Network Exchange model. ONNX is a universal and open-source format designed to facilitate the transfer of trained neural network models across diverse deep learning frameworks. This interoperable standard allows seamless exchange and deployment of machine learning models, enabling compatibility and collaboration between different AI platforms. By utilizing ONNX, developers can convert, optimize, and deploy models across a wide range of environments, fostering innovation and accelerating the development and deployment of AI applications.

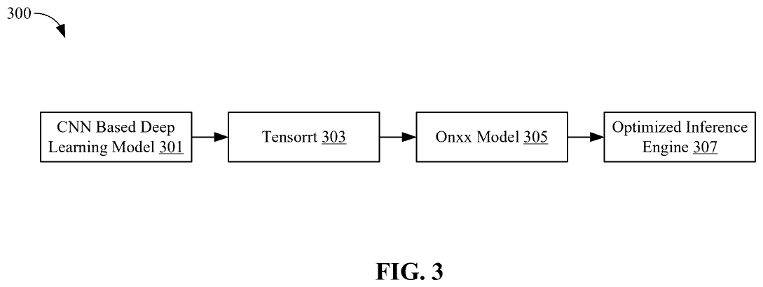

In an embodiment, the generated ONNX model is used by an inference engine which will run on different core of the processor of the user device 105 for processing different parts of the image data. The inference engine uses a multi-threaded architecture that may be designed to use parallel processing capabilities across all the available cores of the processor of the user device 105. The integration may insure that the machine learning model 203d may efficiently process all the segments of image data in parallel, speeding up inference deduction. The generation of the ONNX model is further explained in FIG. 3.

The communication interface 205 may comprise input interface and output interface for supporting communications to and from the user device 105 or any other component with which the system 101 may communicate. The communication interface 205 may be any means such as a device or circuitry embodied in either hardware or a combination of hardware and software that is configured to receive and/or transmit data to/from a communications device in communication with the user device 105. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to manage receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms for enabling the system 101 to conduct information exchange functions in many different forms of communication environments. The communication interface enables exchange of information and instructions with the user device 105 and the mapping platform 103 for receiving and/or transmitting image data and navigation instructions.

FIG. 2B shows format of the map data 200b stored in the map database 103a according to one or more example embodiments. FIG. 2B shows a link data record 207 that may be used to store data about one or more of the feature lines. This link data record 207 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 207 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 207 indicate the position, (e.g., latitude, longitude, and optionally, altitude or elevation) of the selected shape points along the represented link.

Additionally, in the compiled geographic database, such as a copy of the map database 103a, there may also be a node data record 209 for each node. The node data record 209 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 211. The road segment data record 211 is configured to represent data that represents a road network. In FIG. 2C, the map database 103a contains at least one road segment data record 211 (also referred to as “entity” or “entry”) for each road segment in a geographic region.

The map database 103a that represents the geographic region of FIG. 2A also includes a database record 213 (a node data record 213a and a node data record 213b) (or “entity” or “entry”) for each node associated with the at least one road segment shown by the road segment data record 211. (The terms “nodes” and “segments” represent only one terminology for describing these physical geographic features and other terminology for describing these features is intended to be encompassed within the scope of these concepts). Each of the node data records 213a and 213b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 211 contained in the map database 103a. The road segment data record 211 includes a segment ID 211a by which the data record can be identified in the map database 103a. Each road segment data record 211 has associated with it information (such as “attributes”, “fields”, etc.) that describes features of the represented road segment. The road segment data record 211 may include data 211b that indicate the restrictions, if any, on the direction of vehicular travel permitted on the represented road segment. The road segment data record 211 includes data 211c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 211 may also include data 211d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 211 also includes road grade data 211e that indicate the grade or slope of the road segment. In one embodiment, the road grade data 211e include road grade change points and a corresponding percentage of grade change. Additionally, the road grade data 211e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 211e includes the road grade change points and an actual road grade value for the portion of the road segment after the road grade change point until the next road grade change point or end node. In a further embodiment, the road grade data 211e includes elevation data at the road grade change points and nodes. In an alternative embodiment, the road grade data 211e is an elevation model which may be used to determine the slope of the road segment.

The road segment data record 211 also includes data 211g providing the geographic coordinates (e.g., the latitude and longitude) of the end points of the represented road segment. In one embodiment, the data 211g are references to the node data records 211 that represent the nodes corresponding to the end points of the represented road segment.

The road segment data record 211 may also include or be associated with other data 211f that refer to various other attributes of the represented road segment. The various attributes associated with a road segment may be included in a single road segment record or may be included in more than one type of record which cross-reference each other. For example, the road segment data record 211 may include data identifying the name or names by which the represented road segment is known, the street address ranges along the represented road segment, and so on.

FIG. 2C also shows some of the components of the node data record 213 contained in the map database 103a. Each of the node data records 213 may have associated information (such as “attributes”, “fields”, etc.) that allows identification of the road segment(s) that connect to it and/or it is geographic position (e.g., its latitude and longitude coordinates). For the embodiment shown in FIG. 2C, the node data records 213a and 213b include the latitude and longitude coordinates 213a1 and 213b1 for their nodes. The node data records 213a and 213b may also include other data 213a2 and 213b2 that refer to various other attributes of the nodes.

Thus, the overall data stored in the map database 103a may be organized in the form of different layers for greater detail, clarity, and precision. Specifically, in the case of high definition maps, the map data may be organized, stored, sorted, and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 217 in the form of road segments/links, nodes, and one or more associated attributes as discussed above. Furthermore, attributes may refer to features or data layers associated with the link-node database, such as an HD lane data layer.

In addition, the map data 217 may also include other kinds of data 219. The other kinds of data 219 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 215. The indexes 215 may include various types of indexes that relate the different types of data to each other or that relate to other aspects of the data contained in the geographic database 103a.

The data stored in the map database 103a in the various formats discussed above may help in providing precise data for high definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIG. 2B, FIG. 2C and FIG. 2D. The map database 103a may additionally store the image data and the optimized model used for inference deduction that is accessed by the user device 105 for faster processing.

FIG. 3 shows a block diagram that depicts a method for generating an optimized model, such as an ONNX model 305, to be used in an optimized inference engine for image processing, in accordance with an embodiment of the present disclosure. FIG. 3 may include a CNN based deep learning model 301, a TensorRT™ engine 303, the ONNX model 305, and an optimized inference engine 307.

The CNN based deep learning model 301 may represent a program that can be pre-trained on a specific dataset for a particular application using a framework and perform a computer vision task. The CNN based deep learning model 301 may be used in an inference engine to perform the computer vision task. The computer vision task includes different tasks on the images and videos, such as finding and labelling objects, dividing the image into regions, or other tasks that require the understanding of the image content. The CNN based deep learning model 301 may consist of convolution blocks, activation functions, pooling layers, regularization, linear layer, and normalization layers. The convolution blocks may utilize convolutional layers to detect features like edges and textures in the input image data. The activation function may introduce non-linearity. The non-linearity may allow the CNN based deep learning model 301 to learn complex relationships in the image data. Further, the pooling layers may reduce the spatial dimensions. Upon removing the special dimensions, the CNN based deep learning model 301 may focus on notable features while decreasing computational load. The CNN based deep learning model 301 is pre-trained and provided to the TensorRT™ engine 303 for optimization.

The TensorRT™ engine 303 comprises a high-performance deep learning inference library developed that includes instructions to optimize and deploy the pre-trained CNN based deep learning model 301 to run with higher throughput and lower latency.

In an embodiment, the system 101 may incorporate the capabilities of the TensorRT™ engine 303. The process of optimization of CNN based deep learning model 301 may commence with the utilization of lightweight CNN models, pre-trained on application-specific datasets. Then the TensorRT™ engine 303 may function as an optimization engine may dynamically refine the CNN based deep learning model 301 into highly streamlined variants, enhancing their efficiency for deployment. The result may be the generation of the optimized ONNX model 305.

The ONNX model 305 may serve as a versatile translator. The ONNX model 305 may make the CNN based deep learning model 301 communicate with different types of processors or CPU's. The versatility of the ONNX model 305 may make the CNN based deep learning model 301 universally compatible, allowing it to work seamlessly across various computing setups.

The ONNX model 305 is further processed by the optimized inference engine 307. The optimized inference engine 307 may be runtime engine that may be suitable for deployment environment. The optimized inference engine 307 may efficiently execute the inference tasks based on the ONNX model 305. The optimized inference engine 307 may process the image data that may be received by the input module 201b from the sensor module 201a.

In an embodiment, the ONNX model 305 may be passed on to the optimized inference engine 307. The ONNX model 305 that may function as a universal interface may be converted to seamlessly blend with the optimized inference engine 307. The conversion may ensure that it may efficiently translate high-level instructions into a format that may maximise the speed of processing while maintaining the accuracy. The optimized inference engine 307 that may contain the optimized CNN based deep learning model 301 may become a high performance tool for managing the image data from various sources. The image data is processed using the optimized inference engine 307 which is based on inference deduction by segmenting the image data into one or more segments.

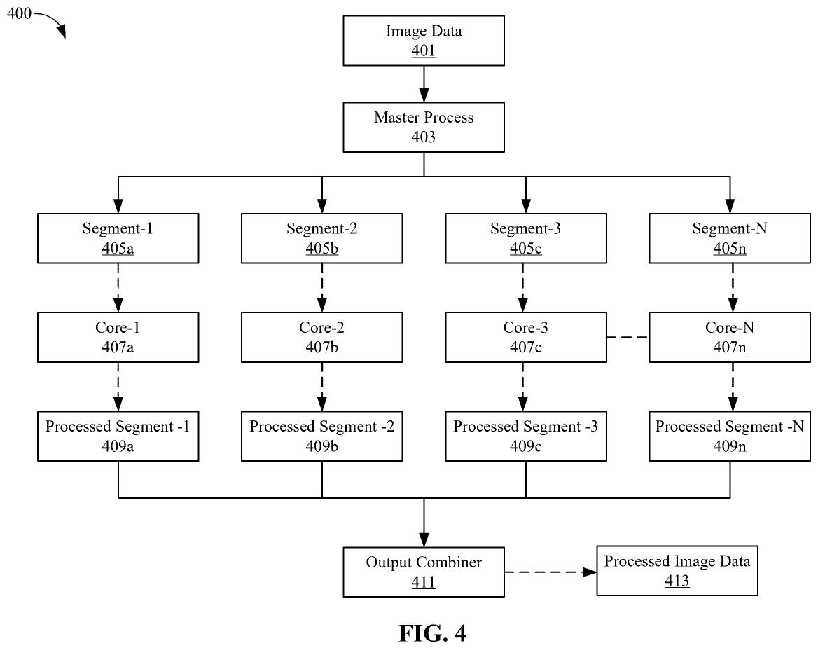

FIG. 4 illustrates a block diagram of a method 400 for segmenting image data 401 according to an image segmentation pipeline, in accordance with an embodiment of the present disclosure. FIG. 4 includes image data 401, a master process 403, a segment-1 405a, a segment-2 405b, a segment-3 405c, up to segment-n 405n. FIG. 4 may further include a core-1 407a, a core-2 407b, a core-3 407c up to core n 407n. Further FIG. 4 may include a processed segment-1 409a, a processed segment-2 409b, a processed segment-3 409c, up to a processed segment-n 409n. FIG. 4 may further include an output combiner 411 and processed image data 413.

In an embodiment, the processor 201 may obtain the image data 401. The image data 401 may be obtained by using the one or more sensors. The one or more sensors may be associated with the user device 105. The image data 401 may include image from diverse data sources including but not limited to CCTV footage, drive files, drone-captured imagery and satellite snapshots.

The image data 401 is transmitted to the master process 403 which is a control unit or a main algorithm responsible for coordinating and overseeing the entire image processing pipeline for the image data 401. The master process 403 is configured to orchestrate various tasks, algorithms, or modules involved in the image processing pipeline to achieve a specific goal.

In one embodiment, the goal is to segment the image data 401 into one or more segments based on the count data. Thus, the master process 403 manages the flow of data and operations between distinct stages or modules of the system 101. For example, the master process 403 obtains the count data 203b from the memory 203 and segments the image data 401 into as many number of segments as indicated by the count data 203b. To that end, the count data 203a may be the total number of cores present in the processor of the user device 105. Further, the master process 403 is configured to allocate the one or more segments of the image data 401 to a corresponding core of the one or more cores of the processor of the user device 105.

As illustrated in FIG. 4, the master process 403 is configured to segment the image data 401 into ‘n’ segments like the segment-1 405a, the segment-2 405b, the segment-3 405c, up to the segment-n 405n. The number of segments of the image data 401 may be based on the count data 203a. To that end, ‘n’ may be a numerical value indicating the number of available cores of the processor of the user device 105. As may be understood by one of ordinary skill in the art, a core of a processor is a component of the processor that is responsible for executing instructions and performing calculations. A processor may include one or more cores, each capable of executing instructions independently. Further, each core comprises its own execution units such as arithmetic logic units (ALUs), floating point units (FPUs), and control units. As a result, each core can independently perform arithmetic, logical, and control operations. Some cores support multithreading, which allows them to manage multiple instruction streams concurrently, further improving efficiency by optimizing resource usage.

For example, when the processor of the user device 105 is a quad core processor, the number of cores and hence the count data is four. The master process 403 may segment the image data 401 into four segments, each segment corresponding to a quadrant of the image represented by the image data 401. Each of the four quadrants is associated with a unique segment identifier 203b. The unique segment identifier 203b may be equivalent to the unique segment identifier 203b explained in the FIG. 2A.

Further, the master process 403 is configured to allocate the segments of the image data 401 such as (the segment-1 405a, the segment-2 405b, segment-3 405c up to segment-n 405n) to the corresponding core of the one or more cores of the processor of the user device 105. The corresponding core of the one or more cores of the processor of the user device 105 may be associated with the core identifier 203c. The core identifier 203c may be equivalent to the core identifier 203c explained in the FIG. 2A.

In an exemplary embodiment, master process 403 may allocate—the segment-1 405a to the corresponding core-1 407a, the segment-2 405b to the core-2 407b, the segment-3 405c to the core-3 407c up to the segment-n 405n to the core-n 407n.

Further, each of the cores then process each of the one or more segments in parallel, thereby increasing the overall processing efficiency of the image processing pipeline. The processing of the image data 401 may be done to accomplish a goal such as object detection, image classification, asset mapping, anomaly detection, identifying features like lane markings, assessing traffic conditions and the like.

Further, after the processing of each of one or more segments of the image data 401 in the corresponding core of the one or more cores of the processor of the user device 105, the one or more cores may output the processed segments such as: the processed segment-1 409a, the processed segment-2 409b, the processed segment-3 409c up to the processed segment-n 409n. For example, the segment-1 405a of the image data 401 that may be processed in the core-1 407a of the processor of the user device 105 may output the processed segment-1 409a. the segment-2 405b that may be processed in the core-2 407b of the processor of the user device 105 may output the processed segment-2 409b. Same process may be followed for the segment-3 405c up to the segment-n 405n.

Once all the segments are processed, the processor 201 of the system 101 may be configured to control the output combiner 411. The output combiner 411 may combine each of the one or more processed segments of the image data 401 to form combined processed image data 413. The one or more processed segments comprise—the processed segment-1 409a, the processed segment-2 409b, the processed segment-3 409c, and the processed segment-n 409n (hereinafter the one or more processed segments are referred to as the processed segments 409a—409n for the sake of brevity of disclosure).

In an example, the master process 403 may be configured to control the output combiner 411 to combine each of the processed segments 409a-409n. Thus, the output combiner 411 may integrate the processed segments from all the one or more cores of the processor of the user device 105. In an example the integration of the processed segments includes an image stitching operation. In other implementations other equivalent image segment combining algorithms may be used without deviating from the scope of the present disclosure. The combined processed image data 413 may represent comprehensive analysis of the entire image data 401, benefiting from the parallelized approach that may accelerate the overall computational efficiency and may enhance the speed of image processing tasks.

In an exemplary embodiment, the processed image data 413 being a processed image of a road, object detection, classification and computer vision tasks may be performed efficiently. The processed image data 413 may be enhanced, with details extracted from distinct parts of the road. The processed image data 413 may be further used for applications such as but not limited to navigational instructions or storage in map databases.

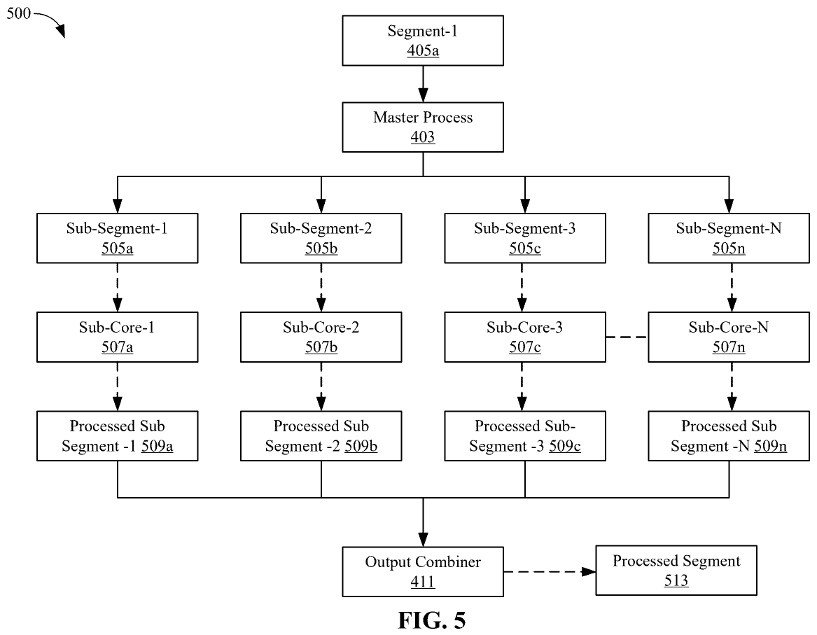

In some embodiments, each segment of the image data 401 may further be sub-segmented so as to leverage multiple sub-cores within each core of the processor of the user device 105, thereby further improving parallelization capability and efficiency of the system 101 for performing any image processing task. This is illustrated in FIG. 5.

FIG. 5 illustrates a block diagram for segmenting segment-1 405a according to an image segmentation pipeline, in accordance with an embodiment of the present disclosure. FIG. 5 may include the segment-1 405a, the-master process 403, a sub-segment-1 505a, a sub-segment-2 505b, a sub-segment-3 505c, up to a sub-segment-n 505n. FIG. 5 may further include a sub-core-1 507a, a sub-core-2 507b, a sub-core-3 507c up to sub-core n 507n. Further FIG. 5 may include a processed sub-segment-1 509a, a processed sub-segment-2 509b, a processed sub-segment-3 509c, up to a processed sub-segment-n 509n. FIG. 5 may further include the output combiner 411 and a processed segment-1 513.

In one embodiment, the processor 201 of the system 101 may use the master process 403 to further segment the segment-1 405a of the image data 401 into one or more sub-segments such as sub-segment-1 505a, sub-segment-2 505b, sub-segment-3 505c up to sub-segment-n 505n. The number of sub-segments of segment-1 405a of the image data 401 may depend on the number of sub-cores present in the core-1 of the processor of the user device 105. The processor 201 of the system 101 may determine the count data 203a. The count data 203a may include the number of available sub-cores in the core of the processor of the user device 105.

In one embodiment, one or more sub-cores may be created inside the each of one or more cores of the processor of the user device 105 to handle specific tasks within the image segmentation process. These tasks may include features of image analysis such as extraction, pattern recognition and the like.

In an exemplary embodiment, the core-1 407a of the processor of the user device 105 may have sub-cores such as sub-core-1 507a, sub-core-2 507b, sub-core-3 507c up to sub-core-n 507n. For example, processor of the user device 105 being a quad core processor, all the four cores of the processor of the user device 105 may have the sub-cores.

In an embodiment, the processor 201 may use the master process 403 to allocate the sub-segments to the sub-cores of the each of one or more cores of the processor of the user device 105. The methodical splitting of the segment-1 405a of the image data may ensure each computational task may be handled precisely. For example, the image data being a satellite image, the satellite image may be segmented by the processor 201 of the system 101 into multiple segments based on the number of cores present in the processor of the user device 105. Further, the processor 201 may further segment each of the one or more segments into multiple sub-segments and allocate the each of one or more sub-segments of each corresponding segment to the corresponding each of one or more sub-cores of one or more cores of the processor of the user device 105.

In an exemplary embodiment, the processor 201, through the master process 403, may allocate the sub-segment-1 505a to the sub-core 507a and generate processed sub-segment-1 509a. The same process may be followed for the sub-segment-2 505b, sub-segment-3 505c up to sub-segment-n 505n. The careful segmentation of the image data that may be determined by count data 205a may optimize the image processing process and may result in efficient and parallelized process.

The output combiner 411 may receive the processed sub-segment-1 509a, the processed sub-segment-2 509b, the processed sub-segment-3 509c up to processed sub-segment-n 509n. The output combiner 411 may combine each of the one or more sub-segments of the segment-1 405a image data 401 to form combined processed segment-1 513. The processed sub-segments of the segment-1 405a of the image data 401 may be subsequently combined by the output combiner 411. The output combiner may integrate the processed sub-segments from all the one or more sub-cores of each of one or more core of the processor of the user device 105. The combined processed segment-1 513 may represent comprehensive analysis of the entire segment-1 405a.

In an exemplary embodiment, the processed segment-1 513 being a processed image of a segment of road, object detection, classification and computer vision tasks may be performed efficiently. The processed segment-1 513 may be enhanced, with details extracted from different parts of the segment of road. The processed segment-1 513 may be further used for applications such as but not limited to navigational instructions or storage in map databases.

Thus, the system 101 is configured to optimize the performance of image processing tasks using the master process 403 that enables segmentation and combining operations for image data 401. In an embodiment, the master process 403 is implemented by the processor 201 of the 101, such as using the master process module 201c shown in FIG. 2A.

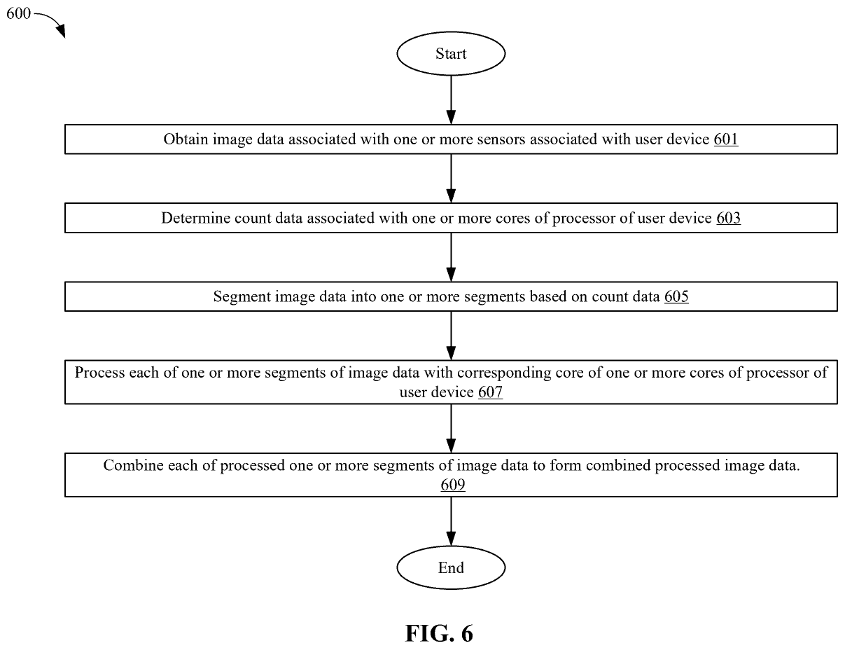

FIG. 6 illustrates a flow diagram of a method for image processing which may be used in an optimized inference engine for image processing, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 600 is generating an optimized model to be used in an optimized inference engine for image processing. Fewer, more, or different steps may be provided.

At 601, the method 600 comprises instructions to obtain image data associated with one or more sensors associated with the user device. In an embodiment, the processor 201 may be configured to obtain image data associated with one or more sensors associated with user device. The image data may be visual information acquired by the sensor module 201a. For example, road scenes, obstacle images, environmental conditions, traffic sign images, and the like. The user device 105 may be any user accessible device such as a mobile phone, a smartphone, a portable computer, and the like.

At 603, the method 600 may comprise instructions to determine count data associated with one or more cores of processor of user device. In an embodiment, the processor 201 may be configured to determine count data associated with one or more cores of processor of user device. The count data may be the number of cores present in the processor associated with the user device 105. The count data may be equivalent to the count data 203a stored in the memory 203.

At 605, the method 600 may comprise instructions to segment image data into one or more segments based on count data. In an embodiment, the processor 201 may be configured to segment image data into one or more segments based on count data. The image data may be segmented based on the number of cores present in the processor of the user device 105. For example, based on the processor of the user device 105 having 4 cores, the image data may be segmented into 4 segments. This has been explained in conjunction with FIG. 4 and FIG. 5.

At 607, the method 600 may comprise instructions to process each of one or more segments of image data with corresponding core of one or more cores of processor of the user device 105. In an embodiment, the processor 201 may be configured to process each of one or more segments of image data with corresponding core of one or more cores of processor of user device 105. For example, the image data having four segments, the first segment that may have segment-id 1 may be processed in the core of the processor of the user device 105 with core id-1, the second segment of the image data that may have segment-id 2 may be processed in the core of the processor of the user device 105 with core id-2, similarly the segments with segment-id 3 and segment-id 4 may be processed by the core of the processor of user device 105 with core-id 3 and core-id 4 respectively. The processor associated with the user device 105 may process the segments in parallel. This has been explained in conjunction with FIG. 4 and FIG. 5.

At 609, the method 600 may comprise instructions to combine each of processed one or more segments of image data to form combined processed image data. In an embodiment, the processor 201 may be configured to combine each of processed one or more segments of image data to form combined processed image data. For example, once the one or more cores of the processor of the user device 105 may process one or more segments of the image data, the output combiner 411 may combine each of the one or more segments into the combined image data. This has been explained in conjunction with FIG. 4 and FIG. 5.

Accordingly, blocks of the flowchart 600 support combinations of means for performing the specified functions and combinations of operations for performing the specified functions. It will also be understood that one or more blocks of the flowchart 600, and combinations of blocks in the flowchart 600, can be implemented by special-purpose hardware-based computer systems which perform the specified functions, or combinations of special-purpose hardware and computer instructions.

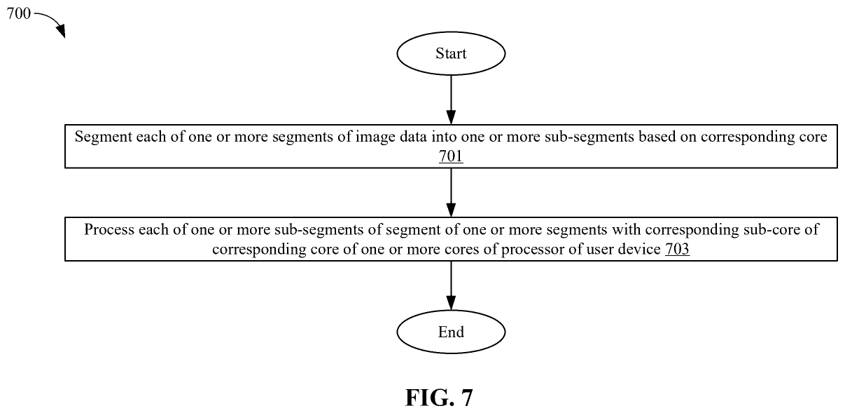

FIG. 7 illustrates a flow chart of another method 700 for image processing, in accordance with one or more example embodiments. At 701, the method 700 may comprise instructions to segment each of one or more segments of image data into one or more sub-segments based on corresponding core. In an embodiment, the processor 201 associated with the system 101 may be configured to segment each of one or more segments of image data into one or more sub-segments based on corresponding core. The corresponding core may correspond to one or more sub-cores of each of one or more core of the processor of the user device 105. This has been previously explained in conjunction with FIG. 5.

At 703, the method 700 may comprise instructions to process each of one or more sub-segments of segment of one or more segments with corresponding sub-core of corresponding core of one or more cores of processor of user device 105. In an embodiment, the processor 201 of the system 201 may be configured to process each of one or more sub-segments of segment of one or more segments with corresponding sub-core of corresponding core of one or more cores of processor of user device 105. This has been previously explained in conjunction with FIG. 5.

In some embodiments, the system 101 may comprise means for performing each of the operations described above in conjunction with methods 600 and 700. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

I/We claim:

1. A method, comprising:
obtaining image data associated with one or more sensors associated with a user device;
determining count data associated with one or more cores of a processor of the user device;
segmenting the image data into one or more segments based on the count data;
processing each of the one or more segments of the image data with a corresponding core of the one or more cores of the processor of the user device; and
combining each of the processed one or more segments of the image data to form combined processed image data.

2. The method of claim 1, wherein each of the one or more segments of the image data is associated with a segment identifier, and each of the one or more cores of the processor of the user device is associated with a core identifier.

3. The method of claim 2, further comprising combining each of the processed one or more segments of the image data based on the segment identifier and the core identifier.

4. The method of claim 1, further comprising:
segmenting each of the one or more segments of the image data into one or more sub-segments based on the corresponding core; and
processing each of the one or more sub-segments of a segment of the one or more segments with a corresponding sub-core of the corresponding core of the one or more cores of the processor of user device.

5. The method of claim 1, further comprising:
segmenting, using a master process, the image data into the one or more segments; and
allocating, using the master process, each of the one or more segments to the corresponding core of the one or more cores of the processor of the user device.

6. The method of claim 1, further comprising generating a navigation instruction based on the combined processed image.

7. The method of claim 1, further comprising storing the combined processed image in a map database.

8. The method of the claim 1, wherein the processing of each of the one or more segments of the image data with a corresponding core of the one or more cores is performed in parallel.

9. The method of claim 1, wherein the count data is indicative of a number of available cores of the processor of the user device, for processing the image data.

10. A system, comprising:
a memory configured to store computer-executable instructions; and
at least one processor configured to execute the computer-executable instructions to:
obtain image data associated with one or more sensors associated with a user device;
determine count data associated with one or more cores of a processor of the user device;
segment the image data into one or more segments based on the count data;
process each of the one or more segments of the image data with a corresponding core of the one or more cores of the processor of the user device; and
combine each of the processed one or more segments of the image data to form combined processed image data.

11. The system of claim 10, wherein each of the one or more segments of the image data is associated with a segment identifier, and each of the one or more cores of the processor of the user device is associated with a core identifier.

12. The system of claim 11, wherein the at least one processor is further configured to combine each of the processed one or more segments of the image data based on the segment identifier and the core identifier.

13. The system of claim 10, wherein the at least one processor is further configured to:
segment each of the one or more segments of the image data into one or more sub-segments based on the corresponding core; and
process each of the one or more sub-segments of a segment of the one or more segments with a corresponding sub-core of the corresponding core of the one or more cores of the processor of user device.

14. The system of claim 10, wherein the at least one processor is further configured to:
segment, using a master process, the image data into the one or more segments; and
allocate, using the master process, each of the one or more segments to the corresponding core of the one or more cores of the processor of the user device.

15. The system of claim 10, wherein the at least one processor is further configured to generate a navigation instruction based on the combined processed image.

16. The system of claim 10, wherein the at least one processor is further configured to store the combined processed image in a map database.

17. The system of the claim 10, wherein the processing of each of the one or more segments of the image data with a corresponding core of the one or more cores is performed in parallel.

18. The system of claim 10, wherein the count data is indicative of a number of available cores of the processor of the user device, for processing the image data.

19. A non-transitory computer-readable medium having stored thereon computer-executable instructions, which when executed by a computer, cause the computer to execute operations, the operations comprising:
obtaining image data associated with one or more sensors associated with a user device;
determining count data associated with one or more cores of a processor of the user device;
segmenting the image data into one or more segments based on the count data;
processing each of the one or more segments of the image data with a corresponding core of the one or more cores of the processor of the user device; and
combining each of the processed one or more segments of the image data to form combined processed image data.

20. The computer programmable product of claim 19, further comprising:
segmenting each of the one or more segments of the image data into one or more sub-segments based on the corresponding core; and
processing each of the one or more sub-segments of a segment of the one or more segments with a corresponding sub-core of the corresponding core of the one or more cores of the processor of user device.
